(19) United States
(12) Patent Application Publication
(10) Pub. No.: US 2015/0351170 A1
(43) Pub. Date: Dec. 3, 2015

(54) METHODS SYSTEMS AND DEVICES FOR MINIMIZING POWER LOSSES IN LIGHT EMITTING DIODE DRIVERS

(71) Applicants: James E. Thompson, San Tan Valley, AZ (US); Grant Elliott, Hong Kong (HK)

(72) Inventors: James E. Thompson, San Tan Valley, AZ (US); Grant Elliott, Hong Kong (HK)

(73) Assignee: Screen Labs America, Inc., Galveston, TX (US)

(21) Appl. No.: 14/289,561

(22) Filed: May 28, 2014

(51) Int. Cl. H05B 33/08

(52) U.S. Cl. CPC H05B 33/0809

(57) ABSTRACT

Devices, systems, and methods for minimizing power losses in light emitting diode drivers are disclosed. In one aspect a system comprises a constant current LED driver comprising a regulation detector configured to detect if the driver is regulating current and send feedback to a controller configured to adjust the output voltage of an adjustable power supply to be substantially equal to the minimum voltage required for the driver to be in regulation.

### FIELD OF THE INVENTION

This invention relates generally to devices, systems, and methods for minimizing power losses in light emitting diode drivers.

### DESCRIPTION OF THE RELATED ART

Power consumption of light emitting diode (LED) video display systems can be lowered by reducing the forward voltage of an LED or by minimizing losses in the LED driver. The forward voltage of an LED is determined by its chemistry thus it is often difficult to adjust this value. Another challenge is the production variability in the forward voltage of the LEDs in the display. Due to process variations, the forward voltage of the LEDs can vary significantly and this has a direct bearing on power consumption.

While designing LED drivers, it may not be practical to design the system based on the actual voltage requirements of each LED since each driver would need to be designed for the specific LEDS used. Therefore, a system that adjusts voltage to run at an optimal level is desirable.

U.S. Patent Publication No. 2008/0018266 to Yu et al. describes a DC-DC conversion circuit with a variable output voltage for a backlight system of an LCD display. In this system the voltage across the LED string is measured and the output voltage is varied to match the minimum voltage needed by the load.

It would be desirable to provide alternative and improved devices, systems, and methods for minimizing power losses in light emitting diode drivers. At least some of these objectives will be met by the inventions described herein below.

### SUMMARY OF THE INVENTION

In one aspect, the present application discloses a system for minimizing power losses in LED drivers. In one embodiment, the system comprises an LED, a constant current LED driver comprising a regulation detector configured to detect if the driver is regulating current, an adjustable power supply for supplying an output voltage to the LEDs and the drivers, and a controller configured to control the adjustable power supply. The regulation detector is configured to provide regulation feedback to the controller and the controller is configured to adjust the output voltage based on the feedback to be substantially equal to the minimum voltage required for the driver to be in regulation.

In one embodiment, the system is configured to detect if the driver is regulating current by detecting collapse of a cascoded current mirror. In another embodiment, the system is configured to measure a voltage of the driver and compare it to a knee voltage of the driver to determine if the driver is regulating current. In yet another embodiment, the system is configured to measure current through the driver and compare the measured current to a desired current to determine if the driver is regulating current. In another embodiment the system is configured to monitor the cascoded current mirror to detect an open-circuit error condition.

In another aspect, power loss is minimized by a) detecting if a constant current LED driver is regulating current using a regulation detector; b) decreasing an output voltage of an adjustable power supply using a controller if the driver is regulating current, and repeating step a); and c) increasing the output voltage using the controller if the driver is not regulating current, and repeating step a); wherein steps a) through c) are repeated until the driver is regulating current and the output voltage is substantially equal to the minimum voltage required for the driver to be in regulation. In an embodiment, the magnitude of the voltage changes decreases with successive cycles. The cycles may be periodically or continuously repeated to the minimum voltage required for the driver to be in regulation

This, and further aspects of the present embodiments are set forth herein.

### BRIEF DESCRIPTION OF THE DRAWINGS

Present embodiments have other advantages and features which will be more readily apparent from the following detailed description and the appended claims, when taken in conjunction with the accompanying drawings, in which:

FIG. 1 is an exemplary circuit diagram of an LED system.

FIG. 2 is a graph showing current regulation of an LED driver.

FIG. 3 is an exemplary circuit diagram of an LED system having multiple LEDs and LED drivers.

FIG. 4 is an exemplary circuit diagram of a system with a regulation detector and adjustable power supply.

FIGS. 5-7 show embodiments of methods for optimizing voltage based on regulation feedback.

FIG. 8 is an exemplary circuit diagram of a multiple LED system with regulation detectors and an adjustable power supply.

FIG. 9 is an exemplary embodiment of a multi LED system having a single regulation detector.

FIGS. 10A-10B show an exemplary current mirror.

FIGS. 11A-11C show an exemplary cascode current mirror.

FIG. 12 shows an exemplary current mirror with a regulation detector.

FIG. 13 shows a multi-mirror system with regulation detectors.

FIG. 14 shows current mirror with a regulation detector at the transistor level.

FIG. 15 is a circuit diagram of a single pixel driver.

FIG. 16 illustrates a single pixel driver system comprising an adjustable power supply integrated into a single chip.

FIG. 17 is a circuit diagram of a single pixel driver.

FIG. 18 is one embodiment of a single pixel driver system.

FIG. 19 shows an embodiment of a driver integrated circuit.

FIG. 20 shows a system comprising multiple driver integrated circuits.

### DETAILED DESCRIPTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The word “exemplary” is used herein to mean “serving as an example, instance, or illustration.” Any implementation described herein as “exemplary” is not necessarily to be construed as advantageous over other implementations.

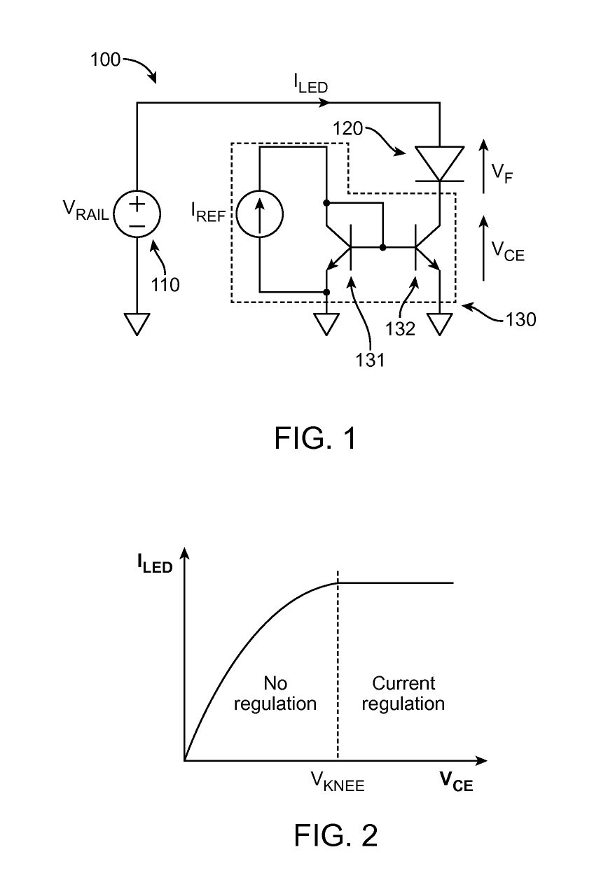

The present disclosure describes devices, systems, and methods for minimizing power losses in LED drivers. LEDs may be driven by a constant current source or sink. In an embodiment, this constant current driver is implemented using a current mirror. FIG. 1 shows an exemplary circuit diagram of an LED system. The system 100 comprises a voltage source 110 of voltage V_{RAIL}, an LED 120, and an LED driver 130. Voltage source 110 supplies voltage V_{RAIL} to the LED 120 and the LED driver 130. In one embodiment, LED driver 130 is a constant current driver such as a current mirror. While the term “constant current” is used herein, the current of the LED driver 130 may not be perfectly constant. “Constant current” is used herein to include the minor variances in current present in a current mirror while regulating current. LED driver 130 may comprise two NPN bipolar junction transistor (BJT) devices 131, 132. While, FIG. 1 depicts a current mirror comprising NPN BJTs, alternatively or additionally current mirrors may comprise other transistors such as PNP BJTs or metal-oxide-semiconductor field-effect transistors (MOSFETs).

Under normal operating conditions the current through the LED (I_{LED}) is controlled by reference current I_{ref}. For a given current, I_{LED}, a forward voltage is generated across the LED (V_{F}). Sufficient collector-emitter voltage is required across transistor 132 (V_{CE}) in order for the current mirror to function properly and maintain current regulation. This minimum voltage is referred to as the compliance voltage or knee voltage (V_{KNEE}). FIG. 2 shows a graph of the voltage across the mirror output (V_{CE}) versus I_{LED}. Once current regulation has been established at V_{KNEE}, V_{CE} increases however the current does not as it is now regulated, and the resulting power increase is dissipated as heat within the device. Thus, in order for the LED 120 to operate at the desired current;

V_{RAIL}≧V_{F}+V_{KNEE}

The power lost in the LED driver 130 is approximated by:

P=V_{CE}×I_{LED}

This can be re-arranged as follows:

P=((V_{CE}−V_{KNEE})+V_{KNEE})×I_{LED}

As a minimum voltage of V_{KNEE} is needed to ensure current regulation, in order to minimize the losses in the driver 130, the voltage at which the current driver regulates, V_{KNEE}, may be minimized. Also, loses in the driver may be minimized by ensuring that V_{CE} is equal to V_{KNEE}. In which case minimum losses are approximately:

P=V_{KNEE}×I_{LED}

where:

V_{RAIL}=V_{F}+V_{KNEE}

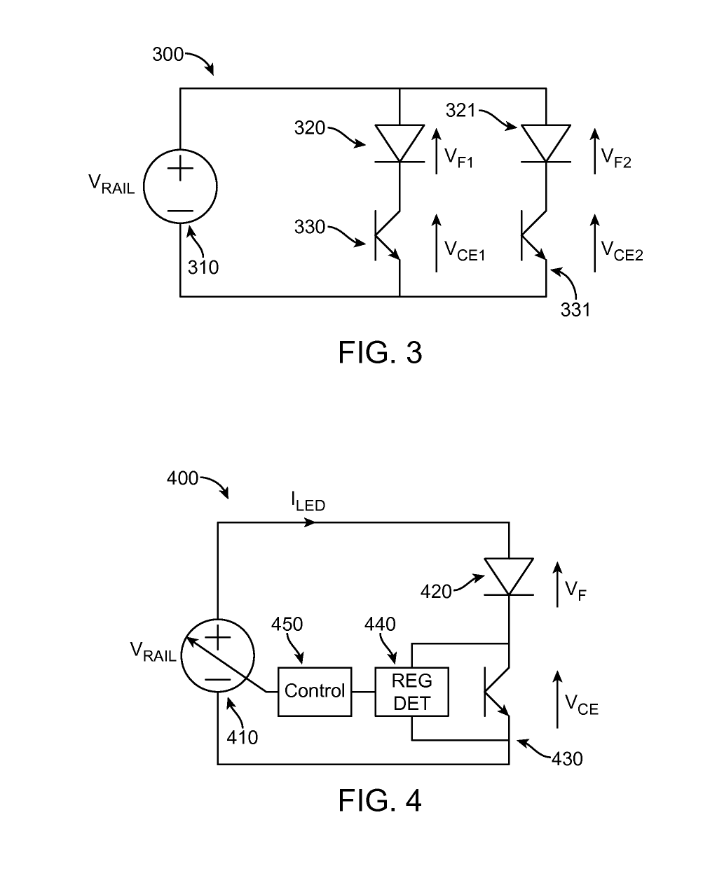

FIG. 3 shows an exemplary circuit diagram of an LED system having multiple LEDs and LED drivers. In this and other figures only one transistor for each mirror is drawn for simplicity and the rest of the current mirror is assumed. System 300 comprises a voltage source 310 configured to supply a voltage V_{RAIL} to a first LED 320, a first LED driver 330, a second LED 331, and a second LED driver 331. The first LED 320 has a forward voltage of V_{F1} and the first LED driver 330 has a drain to source voltage of V_{CE1}. The second LED 321 has a forward voltage of V_{F2} and the second LED driver 331 has a drain to source voltage of V_{CE2}. In order for both the first LED driver 330 and the second LED driver 331 to be regulating correctly, and consequently, both the first LED 320 and the second LED 321 to be operating fully saturated, V_{RAIL} must be:

V_{RAIL}≧MAX(V_{F1}+V_{KNEE1},V_{F2}+V_{KNEE2})

Given that the variation of V_{KNEE} between drivers 330, 331 is typically very small, the equation above can be simplified to:

V_{RAIL}≧V_{KNEE}+MAX(V_{F1},V_{F2})

Therefore, for a system with minimal driver loss:

V_{RAIL}=V_{KNEE}+MAX(V_{F1},V_{F2})

Thus for multi LED system running from a shared voltage rail, V_{RAIL} should be set to allow for the LED with the highest forward voltage and for V_{KNEE}.

The need for a mechanism to minimize power consumption of the LED system can be shown in an exemplary display system comprising LEDs having an average V_{F}=3.2V, a specified maximum V_{F}=4.0V but an actual maximum V_{F}=3.6V. In this exemplary system multiple LEDs are used at any one time and operated from a single rail. Here there is a distribution of V_{F} which needs to be taken into consideration when selecting the voltage. It is often impractical to measure the worst case LED in a given batch. Thus, without a means for minimizing losses in the driver, the rail voltage would need to allow for the worst case specified V_{F} or 4.0V despite the fact that the average V_{F} is 3.2V and the actual maximum V_{F} is 3.6V. Here, if V_{KNEE} is 0.5V, the voltage across the LED and driver rail for the LEDs would be at minimum 4.5V where the average voltage required is 3.7V. This equates to 22% more power being used than is actually required for all LEDs to sufficiently biased.

In order to minimize losses in the driver, a mechanism may be used that ensures sufficient voltage is supplied to ensure current regulation in all LEDs, and no more. While it would be possible to measure the V_{F} to ensure that an LED is fully biased, this may be impractical both from a measurement perspective since there would be many measurements, secondly due to the variation in V_{F} due to manufacturing tolerances and finally variation in V_{F} due to changes in operational conditions such as forward current and temperature. Since if all the current mirrors in a system are regulating correctly then the LEDs are all operating correctly, the system may be optimized by adjusting V_{RAIL} so that the driver of the LED with the highest V_{F} has just enough voltage to ensure regulation is achieved.

FIG. 4 shows an exemplary circuit diagram of a single LED system with a regulation detector and adjustable power supply. This system 400 comprises an LED 420 with a forward voltage V_{F}, an LED driver 430 with a drain to source voltage of V_{CE}, an adjustable power supply 410 configured to supply a voltage V_{RAIL} to the LED 420 and the LED driver 430, and a controller 450. In an embodiment, the adjustable power supply 410 comprises a DC-DC converter configured to adjust V_{RAIL}. Controller 450 is configured to control the adjustable power supply 410. LED driver 430 is a constant current driver comprising a regulation detector 440 configured to detect if the LED 420 is regulating current.

The regulation detector 440 is connected to the controller 450 and is configured to provide regulation feedback to the controller 450. Feedback from the regulation detector 440 to the controller 450 can be implemented using a number of methods, including but not limited to discrete feedback and/or via a digital communication network. The controller 450 is configured to adjust V_{RAIL} based on the feedback from the regulation detector 440 to ensure that the driver 430 is only just in regulation, minimizing V_{RAIIL} and consequently minimizing the losses in the driver 430. In an embodiment, the controller 450 is configured to lower V_{RAIL} if the driver 430 is operating above its knee point and raise V_{RAIL} if the driver 430 is operating below its knee point. V_{RAIL} is thus adjusted to be substantially equal to the minimum voltage required for the LED driver 430 to be in regulation. Regulation detector 440 may operate continuously as V_{F} may vary with current and temperature.

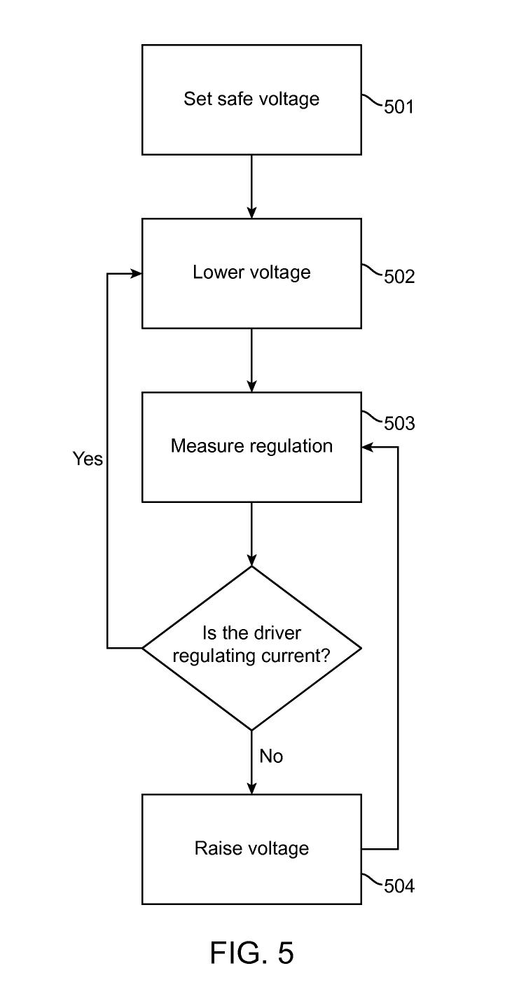

FIG. 5 shows a method of optimizing voltage based on regulation feedback. In one embodiment, at step 501, the controller starts by setting V_{RAIL} to a safe voltage where, based upon the specification and binning of the LEDs and drivers, all LEDs will run with all drivers regulating current. At step 502, the controller lowers V_{RAIL}. At step 503, the regulation detector measures whether the driver is regulating current and sends regulation feedback to the controller. If at step 503, the driver is regulating current, step 502 is repeated and the voltage is lowered. If at step 503 the driver is not regulating current, voltage is raised at step 504. After voltage is raised at step 504, step 503 is repeated and regulation is measured. This process is repeated and V_{RAIL} reaches the minimum voltage required for current regulation. The magnitude of the voltage changes at 502 and 504 may decrease with successive cycles in order to more finely tune V_{RAIL} to the optimum voltage for current regulation. In one embodiment, once the optimum voltage is reached, this operation is periodically repeated to ensure that this state is maintained. In another embodiment this operation is continually repeated.

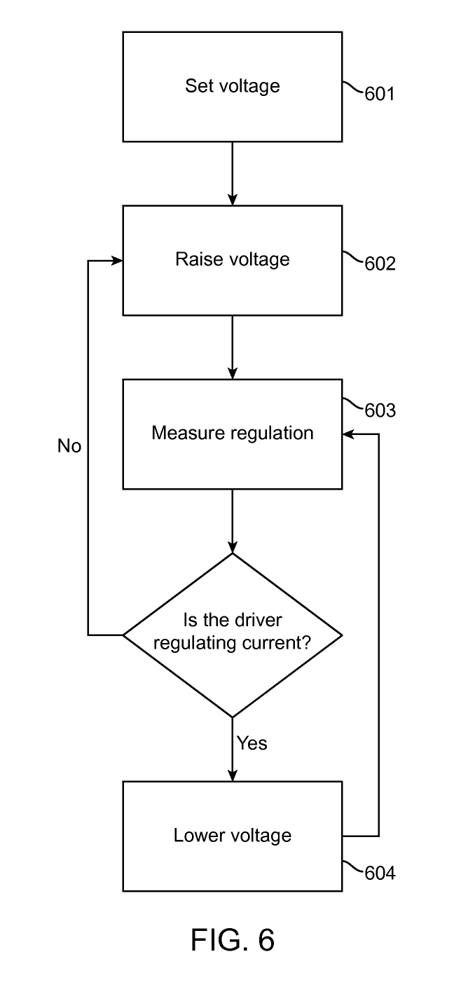

Alternatively, as is depicted in FIG. 6, the controller could start at step 601 by setting the voltage at a voltage lower than what is needed. At step 602, the controller raises V_{RAIL}. At step 603, the regulation detector measures whether the driver is regulating current and sends regulation feedback to the controller. If at step 603, the driver is not regulating current, step 602 is repeated and the voltage is raised. If at step 603 the driver is regulating current, voltage is lowered at step 604. Step 603 is then repeated and regulation is measured. This process is repeated and V_{RAIL} reaches the minimum voltage required for current regulation. The magnitude of the voltage changes at 602 and 604 may decrease with successive cycles in order to more finely tune V_{RAIL} to the optimum voltage for current regulation. In an embodiment, once the optimum voltage is reached, this operation is periodically repeated to ensure that this state is maintained. Alternatively, this operation may continually repeated.

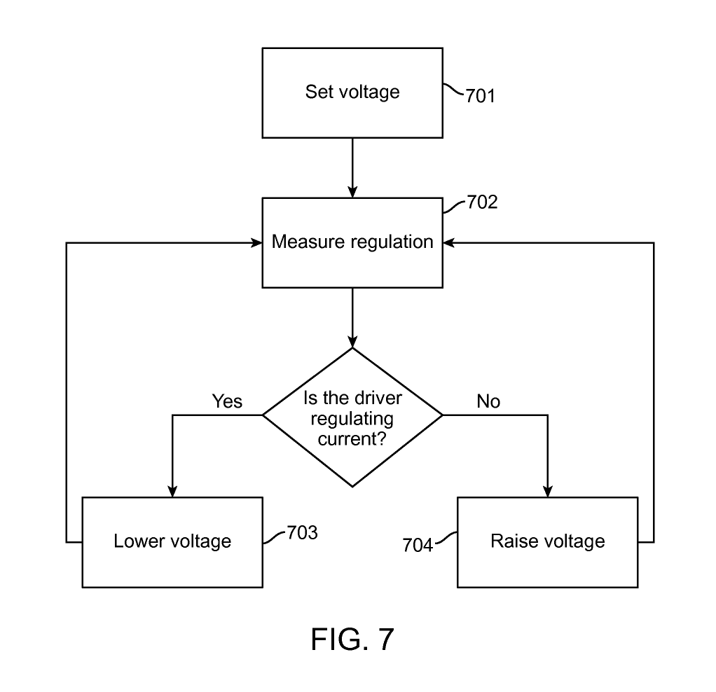

In another embodiment shown in FIG. 7, the regulation detector measures whether the driver is regulating current at step 702 before lowering or raising voltage. At step 703 the voltage is lowered if the driver is regulating current. If the driver is not regulating current, at step 704 the voltage is raised. Step 702 is then repeated and the regulation detector measures whether the driver is regulating current. This cycle may be repeated until V_{RAIL} reaches the minimum voltage required for current regulation. In one embodiment the magnitude of the voltage changes at 703 and 704 decreases with successive cycles in order to more finely tune V_{RAIL} to the optimum voltage for current regulation. In an embodiment, once the optimum voltage is reached, this operation is periodically repeated to ensure that this state is maintained. In another embodiment this operation is continually repeated.

In any of the described devices, systems, and methods, various forms of control may be used such as proportional (P), proportional-integral (PI), proportional-derivative (PD), or proportional-integral-derivative (PID) control.

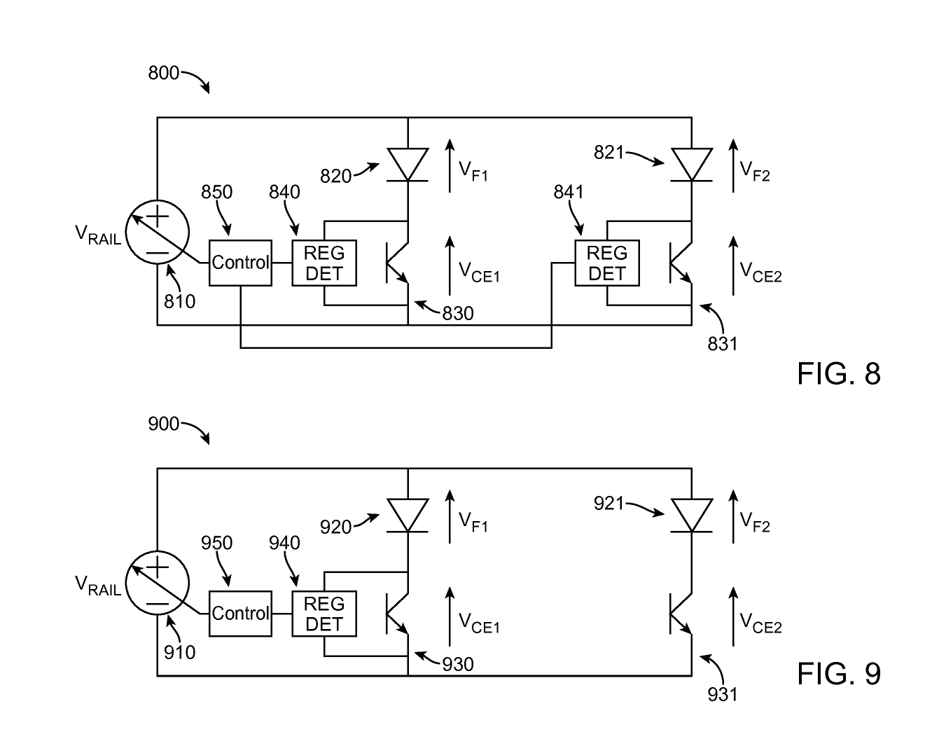

FIG. 8 shows an exemplary circuit diagram of a multiple LED system with regulation detectors and an adjustable power supply. System 800 comprises an adjustable power supply 810 configured to supply a voltage V_{RAIL} to a first LED 820, a first LED driver 830, a second LED 821, and a second LED driver 831. While FIG. 8 depicts an embodiment comprising 2 LEDs 820, 821, other embodiments may comprise 3 or more LEDs. Each LED driver 830, 831 comprises a regulation detector 840, 841 configured to provide regulation feedback for the corresponding LED driver 830, 831 to a controller 850. The controller 850 is configured to adjust V_{RAIL} to ensure the LED with the highest V_{F} is still operating with regulated current, but only just. While one of the two LEDs 820, 821 may not be operating at the optimum V_{F}, the feedback mechanism still ensures that the voltage rail is no higher than it needs to be for the worst case. In an embodiment, the controller 850 is configured to lower V_{RAIL} if the first driver 830 and the second driver 831 are operating above their knee points and raise V_{RAIL} if either the first driver or the second driver is operating below its knee point. V_{RAIL} is thus adjusted to be substantially equal to the minimum voltage required for both the first LED driver 830 and the second LED driver 831 to be in regulation. Additionally, through the use of multiple power rails for a given display, wherein each power rail is arranged so that LEDs operating off that particular rail are binned according to a tight V_{F} range, the system can be optimized further.

FIG. 9 shows an exemplary embodiment of a multi LED system having a single regulation detector. System 900 comprises an adjustable power supply 910 configured to supply a voltage V_{RAIL} to a first LED 920, a first LED driver 930 comprising a regulation detector 940, a second LED 921, a second LED driver 931, and a controller 950. The first LED 920 is known to have a higher V_{F} than the second LED 921. For example, the first LED 920 may be of a different chemistry than the second LED 921 known to have a higher V_{F}. In this embodiment the second LED driver 931 will be in regulation if the first LED driver 930 is in regulation. A regulation detector is therefore not needed for the second LED driver 931 and the controller 850 can adjust V_{RAIL} independent of feedback from the second LED driver or whether the second LED driver is in regulation. Here the controller 950 is configured to adjust V_{RAIL} to ensure the first LED driver 930 is in regulation. The second LED driver 931 will also be in regulation.

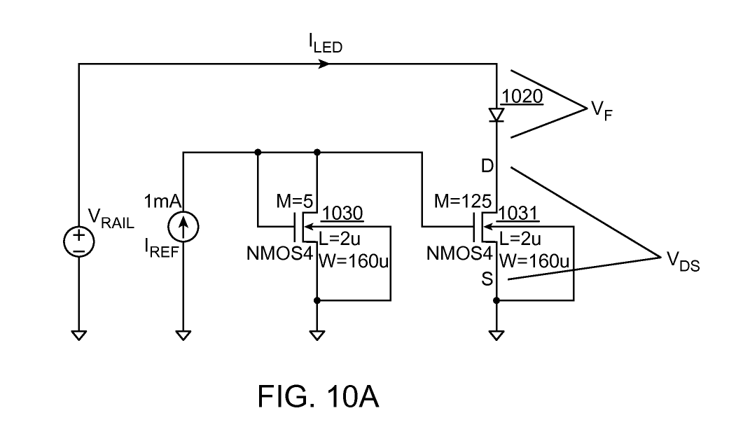

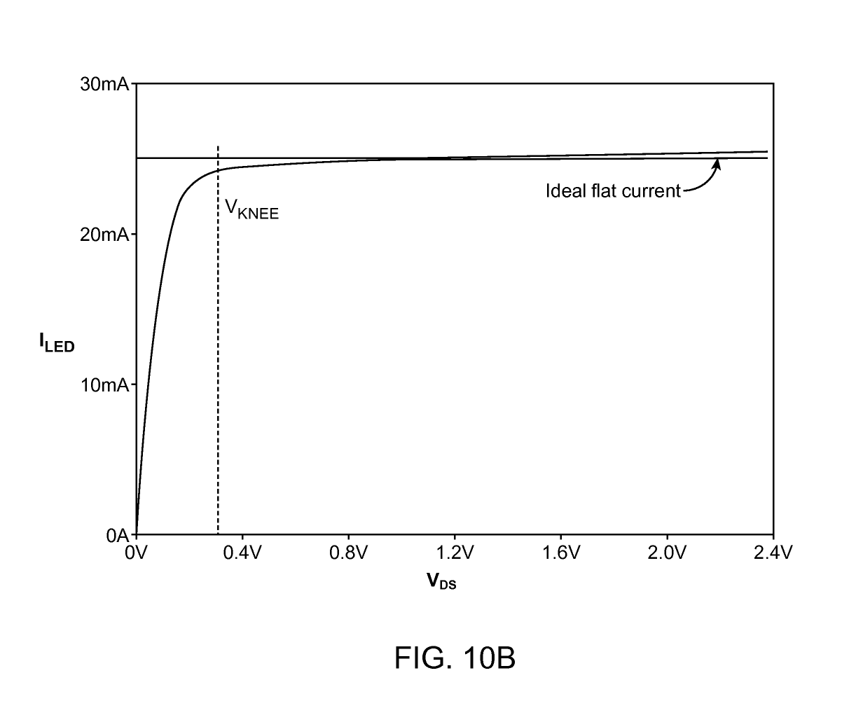

FIG. 10A shows an exemplary current mirror. The following values are exemplary and are not meant as a limitation. While this embodiment of a current mirror is implemented using CMOS devices, other transistor types may be used. Current mirrors can have gain that result from the ratio of the transistor device areas. In this exemplary current mirror, device 1031 has a multiplicity factor equal to 125 and device 1030 has multiplicity factor equal to 5. Length and width are the same for both device 1031 and device 1030. The gain is therefore 125/5=25. With an input current of 1 mA into device 1030, the current into the drain of 1031, should be 25*1 mA=25 mA.

In order ensure current regulation, V_{RAIL}≧V_{F}+V_{DS}. The forward drop across LED 1020 (V_{F}), is determined by the chemistry of LED 1020. The minimum value of V_{DS} such that the mirror is regulating correctly can be determined by performing a simulation on the circuit of FIG. 10A, sweeping the value of V_{RAIL} from zero upwards.

FIG. 10B shows the results of this simulation of the mirror in FIG. 10A whereby V_{RAIL} is varied, but with the X-axis displayed with V_{DS} as the variable. The LED current, I_{LED} is shown as the y-variable. In line with FIG. 2, the current mirror fails to regulate the desired current at values below the point labelled V_{KNEE}. In addition, the gain is not constantly 25, but varies with the value of V_{DS} due to a physical limitation of MOS devices called channel-length modulation. As can be seen in FIG. 10B, the LED current, I_{LED}, varies with V_{DS}.

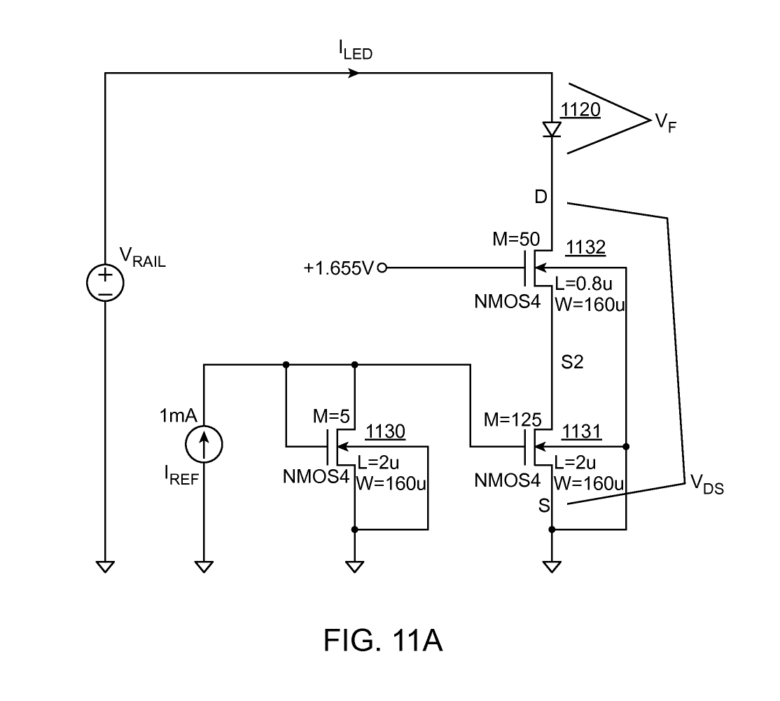

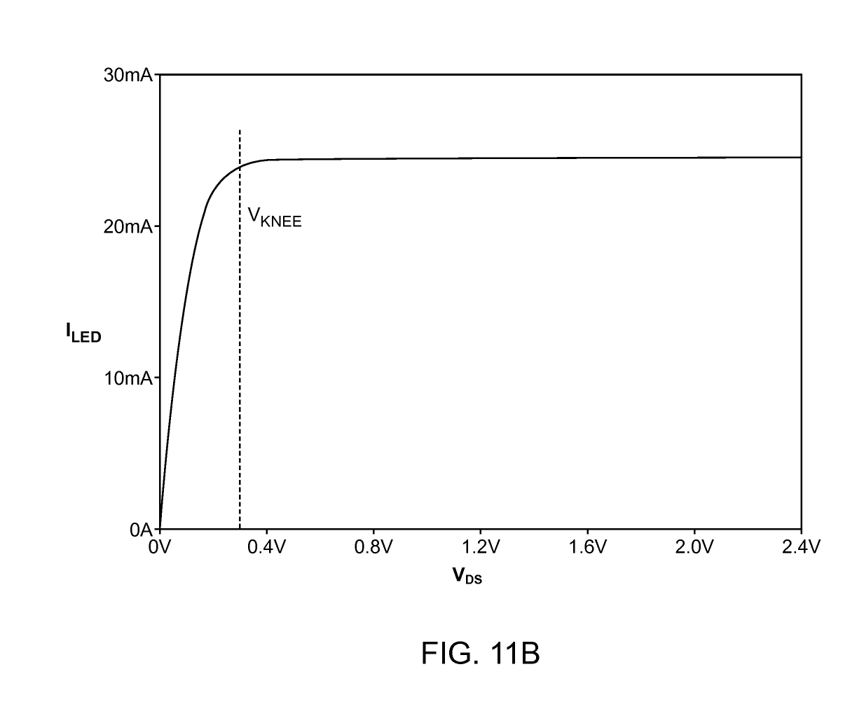

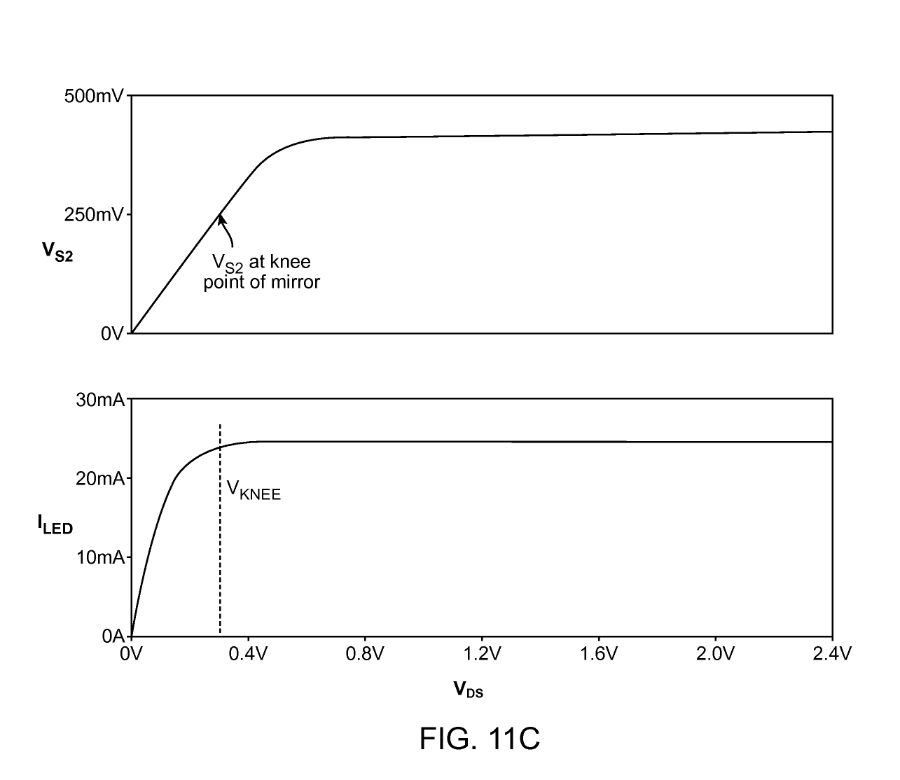

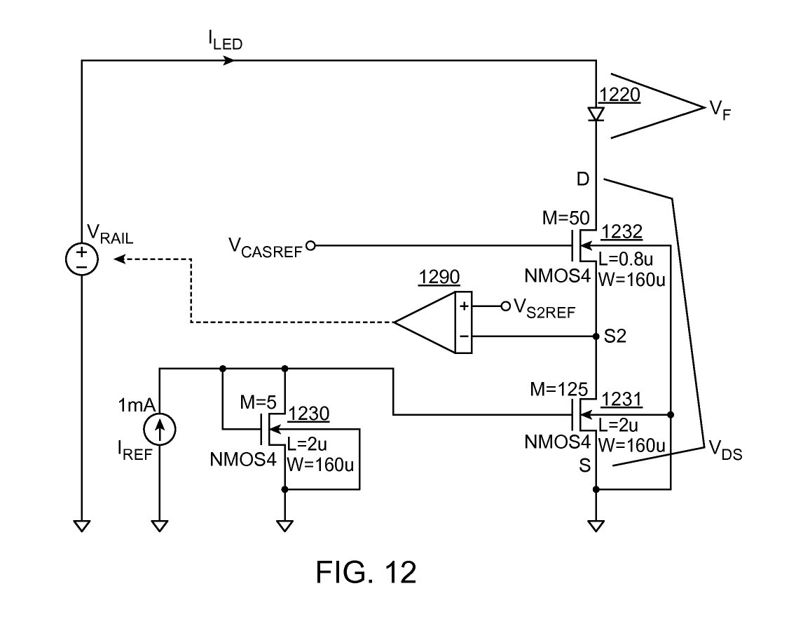

To overcome the variance of current with voltage, a cascode device can be added to the mirror of FIG. 10A as shown schematically in FIG. 11A. The additional device 1132 acts as a shield for the drain of 1131 (node S2), such that voltage variations at node D are greatly attenuated, minimizing the channel-length-modulation effect.

FIG. 10B shows a graph of V_{DS} versus the LED current, I_{LED}, for the mirror in FIG. 11A. As can be seen here, there is significant improvement in flatness of the current, I_{LED}, versus V_{DS}. Additionally the location of V_{KNEE} is unchanged.

FIG. 11C shows the voltage at node S2 of the cascode CMOS circuit shown in FIG. 11A. Here, as V_{DS} decreases from a voltage well above V_{KNEE}, the voltage at node S2 begins falling before the knee voltage is reached for the current mirror. This effect provides a reliable measure of whether the mirror is regulating and consequently a control mechanism by which to regulate V_{RAIL} to an optimized minimum operating voltage, thus minimizing power dissipation in the driver.

A modified version of the circuit of FIG. 11A configured to detect current regulation and minimize power dissipation in the driver is shown in FIG. 12. Here, comparator 1290 compares the voltage at S2, V_{S2}, against a reference potential, V_{S2REF}, which is 250 mV in FIG. 11. If the voltage at node S2 falls below 250 mV, the system increments V_{RAIL} upwards by a small amount until V_{S2}≧V_{S2REF}. Likewise the value of V_{RAIL} may be decremented when voltage at node S2 is above V_{S2REF}. In order to avoid false adjustments, the comparator 1290 may be configured such that it is activated only when the current mirror is also active. In one embodiment, V_{RAIL} has a natural slow decay and the comparator 1290 is configured to increase V_{RAIL} to keep it exactly on target for lowest dissipation. Alternatively, V_{RAIL} may be configured to slowly increase while the comparator 1290 is configured to decrease V_{RAIL} to keep it exactly on target. An added feature of this regulation method is in the fault detection of open circuits. In an embodiment the system is configured to monitor the cascoded current mirror to detect an open-circuit error condition. If the LED or any associated wiring fails open circuit, V_{S2} falls to zero, triggering the comparator 1290 and producing a logic signal denoting a fault condition.

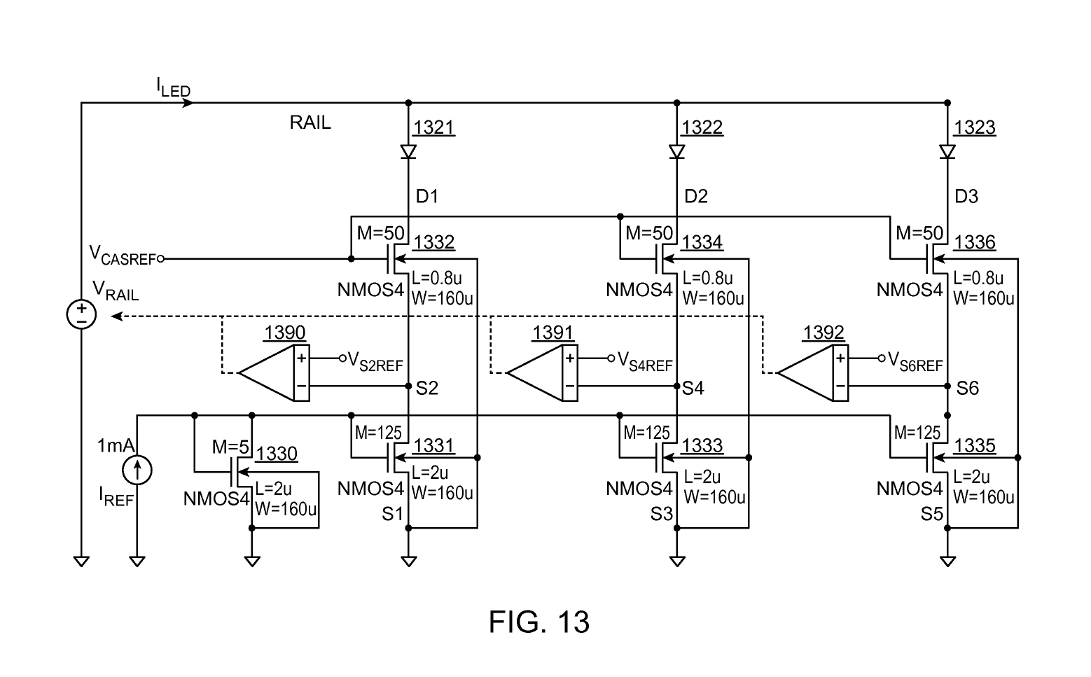

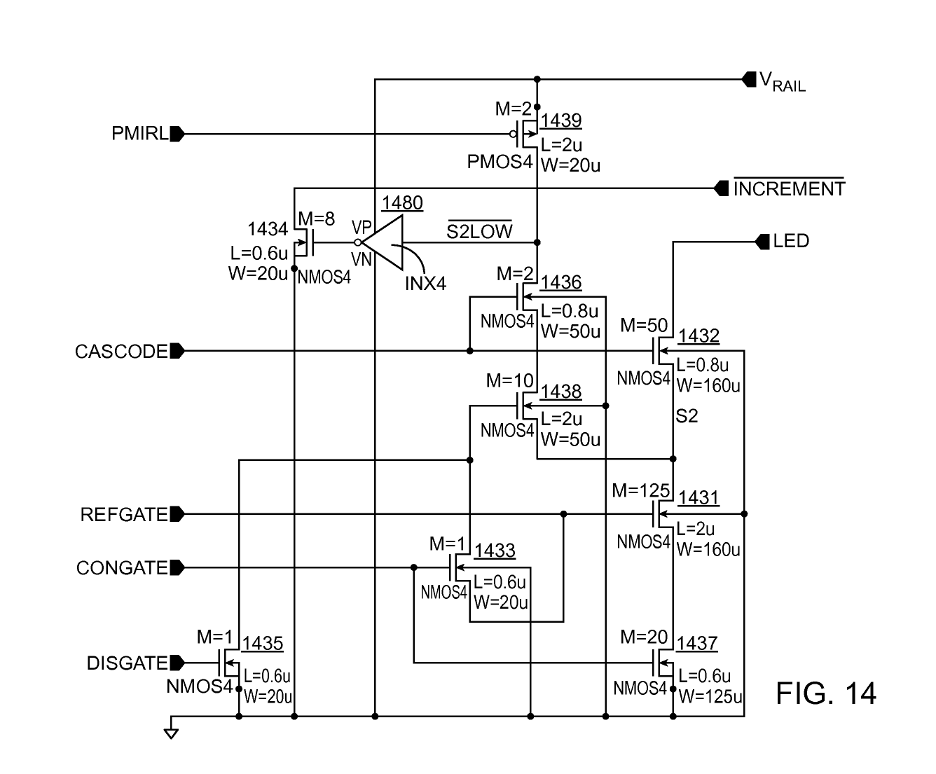

A system comprising multiple LEDs and multiple current mirrors with regulation detectors is shown in FIG. 13. Here the system comprises a comparator 1390, 1391, 1392 for each mirror. By using open drain comparators 1390, 1391, 1392 and wire-OR-ing their outputs, the LED 1321, 1322, 1323 with the highest V_{F} would dominate the control, ensuring that V_{RAIL} is always adequate for all the LEDs 1321, 1322, 1323. While FIG. 13 shows a system comprising three LEDs and three mirrors, other configurations may comprise two, four, or any other number of LEDs and mirrors.

FIG. 14 illustrates a regulation control mechanism at the transistor-level for a single mirror. Devices 1431 and 1432 are configured as the cascoded mirror structure. The reference device from previous figures, is located in a separate centrally-located block and provides the potential at input REFGATE. Devices 1433, 1435 and 1437 serve as switches to activate the mirror. 1436 and 1438, buffered by inverter 1480 and open drain device 1434, serve as the comparator to monitor node S2. 1439 acts as a current mirror load (pull-up) for device 1438. Inputs PMIRL, CASCODE and REFGATE are reference potentials that establish proper mirror accuracy over temperature, supply variations and process corners. Inputs CONGATE and DISGATE turn the mirror on and off. Input V_{RAIL} is the adjustable power supply. The system comprises two outputs, LED to drive the LED, and a signal I̅N̅C̅R̅E̅M̅E̅N̅T̅. Whenever the signal I̅N̅C̅R̅E̅M̅E̅N̅T̅ is low, V_{RAIL} is increased by a suitable increment. Since I̅N̅C̅R̅E̅M̅E̅N̅T̅ is an open drain output, wire-OR-ing this signal from multiple mirrors allows the worst-case condition to command the value of V_{RAIL}.

In another embodiment, the regulation detector could detect whether the driver is in regulation through the use of an internal analog-to-digital converter (ADC) configured to measure the voltage across the output of the mirror V_{CE}. By comparing against a known knee voltage, it can be determined if the driver is regulating correctly. The controller may be configured to adjust for variation in the voltage at which regulation is established as output current varies.

In a further embodiment, the regulation detector could comprise an ADC configured to measure the current through the driver and hence the LED. By comparing this against a desired current, the controller could determine if current regulation is in effect.

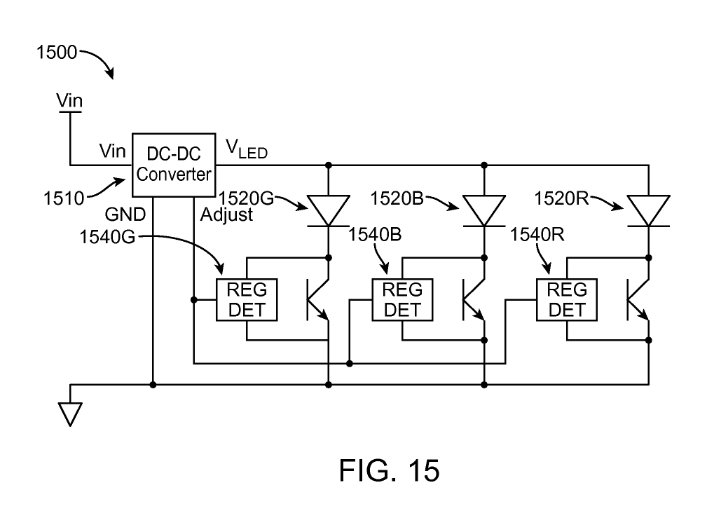

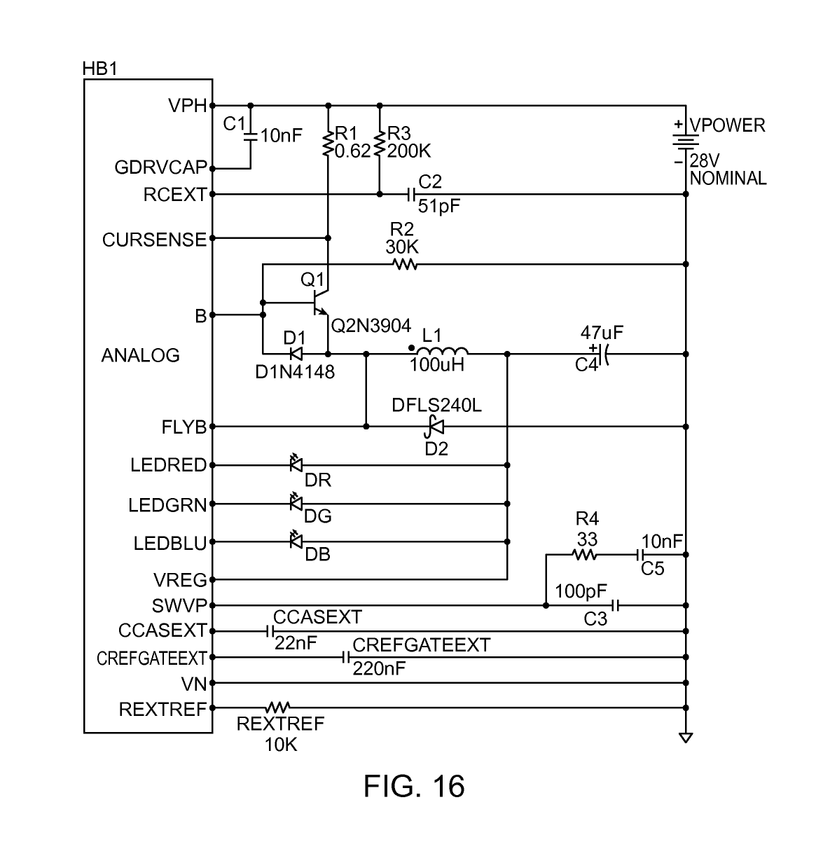

FIG. 15 depicts a circuit diagram of a single pixel driver such as is used in pixel strings or linear applications. In this case a local DC-DC converter 1510 is provided that may or may not be integrated into the driver itself. Here a single DC-DC converter 1510 provides power to each of the LEDs 1520G, 1520B, and 1520R. DC-DC converter 1510 may comprise an integrated controller. Alternatively, a separate controller may control the DC-DC converter 1510. Regulation detectors 1540G, 1540B, and 1540R provide regulation feedback to the DC-DC converter 1510 and V_{RAIL} is adjusted either up or down to ensure each driver is regulating current. While a red-green-blue (RGB) configuration is shown in FIG. 15, other pixel configuration may be used such as red-green-blue-yellow (RGBY), red-green-blue-green (RGBG), etc. In another embodiment, as can be seen in FIG. 16, a single pixel driver system comprises a DC-DC converter integrated into a single chip for use in pixel string applications.

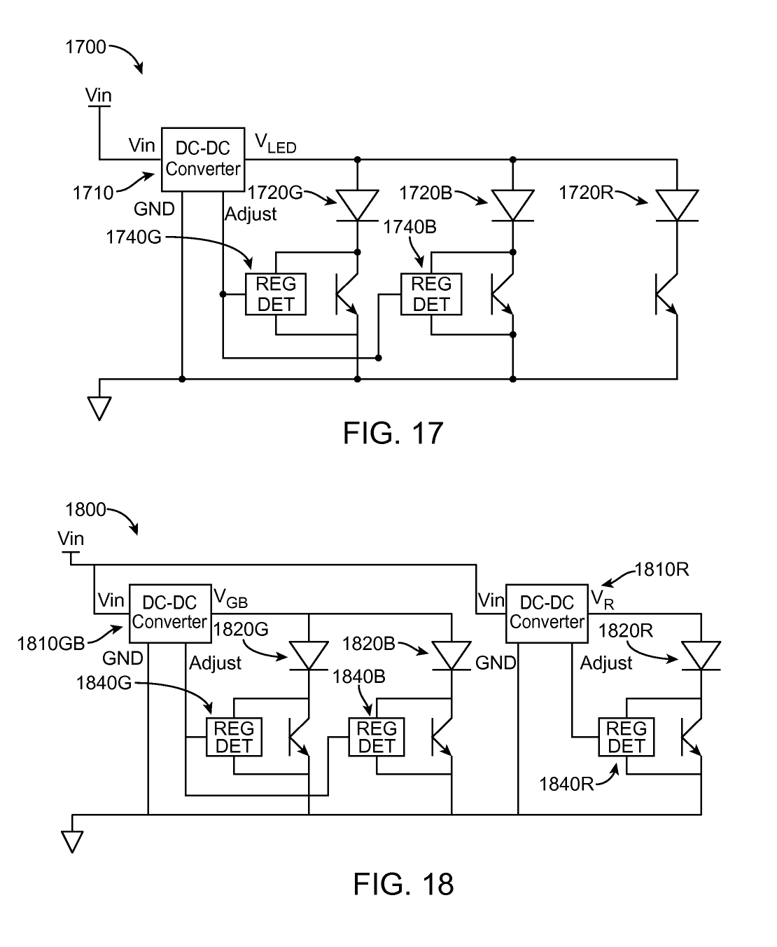

For most applications the V_{F} for green and blue LEDs is significantly higher than for red LEDs due to the difference in the chemistry of the device such that a regulation detector would not be required for the red LED, since if both the green and blue LEDs were saturated, the red LED almost certainly would be as well. FIG. 17 depicts a circuit diagram of a single pixel driver comprising regulation detectors 1740G and 1740B for LEDs 1720G and 1720B without the need for a regulation detector for the red LED 1720R.

Additionally, as can be seen in FIG. 18, two separate rails can be used, V_{GB} for the green and blue LEDs 1820G, 1820B and V_{R} for the red LED 1820R driven respectively by a separate DC-DC converters 1810_{GB}, 1810_{R}. The DC-DC converters 1810_{GB}, 1810_{R} take the input voltage and provide the LED voltage rails V_{GB}, V_{R} at the appropriate level based on the regulation detectors 1840G, 1840B, 1840R in each of the current drivers. For the green and blue LEDs 1820G, 1820B, the voltage is adjusted to ensure both LEDs 1820G, 1820B have regulated current, however the LED voltage rail V_{R} is adjusted for the red LED 1840R. DC-DC converters 1810_{GB}, 1810_{R} may comprise integrated controllers. Alternatively, the controllers may be separate units from the DC-DC converters 1810_{GB}, 1810_{R}. In one embodiment, each DC-DC converter is controlled by a different controller. In another embodiment, a single controller is configured to control multiple DC-DC converters.

Alternative single pixel systems may be configured with separate rails for each LED. Here the red, green, and blue LEDs would each be driven by separate DC-DC converters. For each LED, the voltage rail would be adjusted based on feedback from the respective regulation detector.

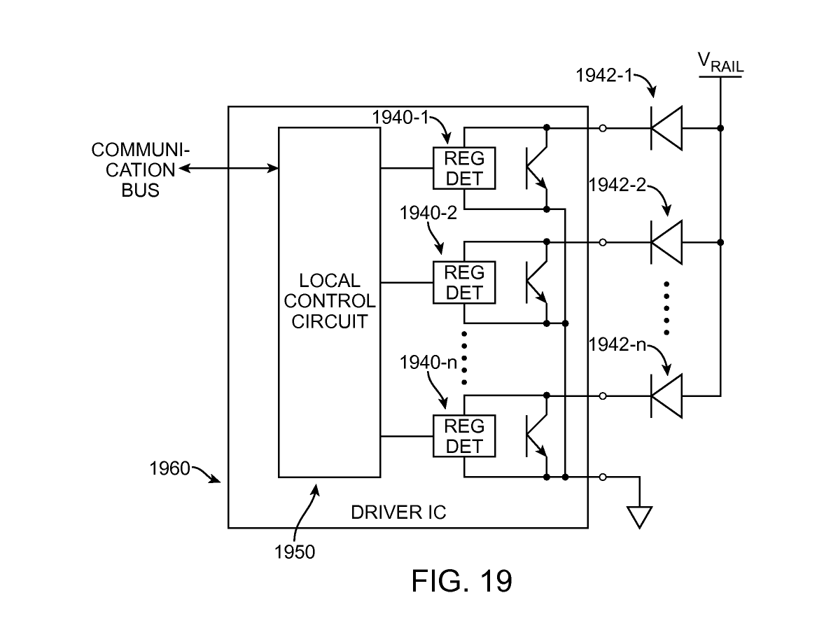

LED displays may be constructed using drivers with a number of constant current outputs, typically sixteen. A driver integrated circuit 1960 is shown in FIG. 19. In one embodiment, each constant current output has a separate regulation detector 1940-1 to 1940-n which feeds back to a local on-chip control circuit 1950. This control circuit 1950 can then feedback the regulation state of any of or any combination of the constant current outputs.

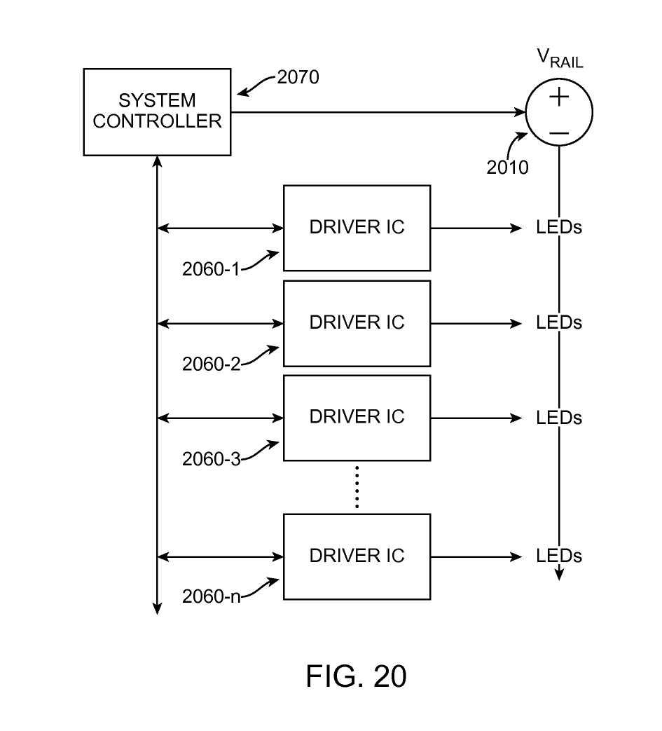

A system comprising multiple driver integrated circuits is shown in FIG. 20. Multiple driver integrated circuits 2060-1 to 2060-n connect via a communication bus to a master controller 2070. This controller 2070 controls the V_{RAIL} for all LEDs connected to the drivers 2060-1 to 2060-n. By interrogating the regulation state of all constant current outputs connected to the bus, the controller 2070 can adjust V_{RAIL} so that only a sufficient voltage is provided to ensure that all current outputs are just regulating. While the communication bus shown here as a multi-drop type configuration, this is purely for demonstrative purposes and is not meant as a restriction. Other architectures such as daisy chain may also be used. Likewise a separate output on each device may be used to communicate the regulation state. In one embodiment, a global wired-OR on the I̅N̅C̅R̅E̅M̅E̅N̅T̅ line is provided as per FIG. 14.

While the above is a complete description of the preferred embodiments of the invention, various alternatives, modifications, and equivalents may be used. Therefore, the above description should not be taken as limiting the scope of the invention which is defined by the appended claims.

1. A system for minimizing power losses in LED drivers comprising:
one or more LEDs;
one or more constant current LED drivers comprising a cascoded current mirror and a regulation detector; wherein the cascoded current mirror comprises a cascode device connected to a current mirror, and wherein the regulation detector is configured to detect if the constant current LED driver is regulating current by sensing a voltage at the node between the cascode device and the current mirror;
an adjustable power supply for supplying an output voltage to the LEDs and the drivers; and
a controller configured to control the adjustable power supply;
wherein the regulation detector is configured to provide regulation feedback to the controller; and
wherein the controller is configured to adjust the output voltage based on the feedback from the regulation detectors such that the drivers are regulating current and the output voltage is substantially equal to a minimum voltage required for the drivers to be in regulation.

2. The system of claim 1, wherein the controller is configured to compare the measured voltage at the node between the cascode device and the current mirror to a reference voltage, and wherein the controller is configured to increase the output voltage to the LEDs and the drivers if the measured voltage drops below the reference voltage and decrease the output voltage to the LEDs and the drivers if the measured voltage is above the reference voltage.

3.-7. (canceled)

8. The system of claim 1, wherein the system is configured to monitor the cascoded current mirror to detect an open-circuit error condition.

9.-14. (canceled)

15. A method for minimizing power losses in LED drivers comprising:
a) detecting if a constant current LED driver comprising a cascoded current mirror is regulating current using a regulation detector; wherein the cascoded current mirror comprises a cascode device connected to a current mirror, and wherein the regulation detector is configured to detect if the constant current LED driver is regulating current by sensing a voltage at the node between the cascode device and the current mirror;
b) decreasing an output voltage of an adjustable power supply using a controller if the constant current LED driver is regulating current, and repeating step a); and
c) increasing the output voltage using the controller if the constant current LED driver is not regulating current, and repeating step a);
wherein steps a) through c) are repeated until the constant current LED driver is regulating current and the output voltage is substantially equal to a minimum voltage required for the constant current LED driver to be in regulation.

16. The method of claim 15, wherein magnitudes of the voltage changes in steps b) and c) decrease with successive cycles.

17. The method of claim 15, further comprising periodically repeating steps a) through c) after the output voltage has reached the minimum voltage required for the constant current LED driver to be in regulation.

18. The method of claim 15, further comprising continuously repeating steps a) through c) after the output voltage has reached the minimum voltage required for the constant current LED driver to be in regulation to maintain the output voltage as substantially equal to the minimum voltage required for the constant current LED driver to be in regulation.

19.-20. (canceled)

21. The method of claim 15, wherein the measured voltage at the node between the cascode device and the current mirror is compared to a reference voltage,
wherein the output voltage of the adjustable power supply is decreased in step b) if the measured voltage is above the reference voltage and wherein the output voltage of the adjustable power supply is increased in step c) if the measured voltage is below the reference voltage.

22. (canceled)

23. The method of claim 15, further comprising monitoring the cascoded current mirror to detect an open-circuit error condition.
